(19) United States
(12) Patent Application Publication
(10) Pub. No.: US 2012/0121128 A1
(43) Pub. Date: May 17, 2012

(54) OBJECT TRACKING SYSTEM

(75) Inventors: John Lawrence, Ottawa (CA); Andrew Scott, Ottawa (CA); Derek Thorslund, Ottawa (CA); Mark Edwards, Ottawa (CA); Emad Hanna, Ottawa (CA)

(73) Assignee: BENT 360: MEDIALAB INC., Ottawa, ON (CA)

(21) Appl. No.: 13/265,459

(22) PCT Filed: Apr. 20, 2010
(86) PCT No.: PCT/CA10/00551

§ 371 Date: Jan. 27, 2012

Related U.S. Application Data
(60) Provisional application No. 61/170,855, filed on Apr. 20, 2009.
(60) Provisional application No. 61/322,267, filed on Apr. 8, 2010.

(51) Int. Cl. G06K 9/00

(52) U.S. Cl. 382/103

(57) ABSTRACT

The present invention provides a system, method and computer program product for tracking the movement of a plurality of targets, wherein the detected movement is used for the modification of an interactive environment. The system comprises one or more imaging devices configured to capture two or more images of at least some of a plurality of target identifiers with one or more of a plurality of targets. The system further comprises a processing module which is operatively coupled to the one or more imaging devices, and configured to receive and process the two or more images. During the processing a first location parameter and a second location parameter for a predetermined region are determined. The one or more movement parameters are at least in part determined from the first and second location parameters and used for the modification of the interactive environment.

### FIELD OF THE INVENTION

The present invention pertains to the field of object tracking systems.

### BACKGROUND

There are a number of object tracking systems which are known in the prior art. For example, cameras have been used to capture images of objects and techniques have been developed to analyze one or more images of an object present in order to detect a position of the object. Optical flow, for example through the use of a plurality of images, has been used to detect motion of an object by analyzing multiple images of the object taken successively in time.

Furthermore, techniques using multiple cameras have been used to provide image data of an object from various different directions and thus enabling the evaluation of relative change in position, velocity or acceleration of that object. These techniques generally call for fixed camera locations and a generally well-known space or system for analysis. For example, detecting characteristics of flight path or trajectory of a rapidly moving object like a bullet or golf ball has been accomplished using rapid exposure photography. The simultaneous use of multiple cameras in various vantage points focused at a common location is generally required to characterize position and/or movement across two or three dimensions.

For example, U.S. Pat. No. 7,058,204 discloses a multiple camera tracking system for interfacing with an application program running on a computer. The tracking system includes two or more video cameras arranged to provide different viewpoints of a region of interest, and are operable to produce a series of video images. A processor is operable to receive the series of video images and detect objects appearing in the region of interest. The processor executes a process to generate a background data set from the video images, generate an image data set for each received video image, compare each image data set to the background data set to produce a difference map for each image data set, detect a relative position of an object of interest within each difference map, and produce an absolute position of the object of interest from the relative positions of the object of interest and map the absolute position to a position indicator associated with the application program.

Furthermore, United States Patent Application Publication No. 2008/0166022 discloses a means for the detection of motion of a user via a camera and the generation of a dynamic virtual representation of a user on a display. In addition, the user's detected motion causes the dynamic virtual representation to interact with virtual objects on the display. The magnitude and direction of the user's detected motion is calculated to determine the magnitude and direction of a force applied by the dynamic virtual representation to the virtual object.

However, in the above systems, typically the position, location, or movement of an object across a trajectory must occur within a fairly well-defined area or location at a fairly well-defined time. Prior analysis of the proximate environment is typically required for proper recognition of the object. Such systems also rely on using very specific objects in known settings which can provide for ease of identification and/or tracking.

As such there is a need in the art to provide an object tracking system and methods which overcome one or more of the drawbacks in the prior art.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide an object tracking system. In accordance with one aspect of the invention there is provided an object tracking system configured to track movement of a plurality of targets for modification of an interactive environment, the system comprising: one or more imaging devices, each imaging device configured to capture two or more images of at least some of a plurality of target identifiers, each of the target identifiers associated with one of the plurality of targets and each target identifier responsive to electromagnetic energy; and one or more processing modules operatively coupled to the one or more imaging devices, the one or more processing modules configured to: receive the two or more images; establish a first location parameter for a predetermined region at least in part based on a first of the two or more images, the predetermined region including one or more of the plurality of target identifiers; establish a second location parameter for the predetermined region based at least in part on a second of the two or more images; determine one or more movement parameters based at least in part on the first location parameter and the second location parameter; and modify the interactive environment based at least in part on the one or more movement parameters.

In accordance with another aspect of the invention there is provided a method for tracking movement of a plurality of targets for modification of an interactive environment, the method comprising: capturing two or more images of at least some of a plurality of target identifiers, each of the target identifiers associated with one of the plurality of targets and each target identifier responsive to electromagnetic radiation; establishing a first location parameter for a predetermined region at least in part based on a first of the two or more images, the predetermined region including one or more of the plurality of target identifiers; establishing a second location parameter for the predetermined region based at least in part on a second of the two or more images; determining one or more movement parameters based at least in part on the first location parameter and the second location parameter; and modifying the interactive environment based at least in part on the one or more movement parameters.

A computer program product for tracking movement of a plurality of targets for modification of an interactive environment, the computer program product comprising code which, when loaded into memory and executed on a processor is adapted to: capture two or more images of at least some of a plurality of target identifiers, each of the target identifiers associated with one of the plurality of targets and each target identifier responsive to electromagnetic radiation; establish a first location parameter for a predetermined region at least in part based on a first of the two or more images, the predetermined region including one or more of the plurality of target identifiers; establish a second location parameter for the predetermined region based at least in part on a second of the two or more images; determine one or more movement parameters based at least in part on the first location parameter and the second location parameter; and modify the interactive environment based at least in part on the one or more movement parameters.

### BRIEF DESCRIPTION OF THE FIGURES

FIG. 1 illustrates an object tracking system in accordance with embodiments of the present invention.

FIG. 2 illustrates an object tracking system in accordance with embodiments of the present invention.

FIG. 3 illustrates a computing environment at least in part representative of a processing system which may be used to implement an embodiment of the present invention.

FIG. 4 illustrates a logic diagram of a method for tracking an object in accordance with embodiments of the present invention.

FIG. 5 illustrates a logic diagram of a method for tracking an object in accordance with embodiments of the present invention.

FIG. 6 illustrates an implementation of the processing system according to an embodiment of the present invention.

FIG. 7 illustrates an implementation of an embodiment of the present invention as a mass audience interactive game.

FIG. 8 illustrates an implementation of an embodiment of the present invention as a mass audience interactive game.

FIG. 9 illustrates an implementation of an embodiment of the present invention as a mass audience interactive game.

FIG. 10 illustrates an implementation of an embodiment of the present invention as a mass audience interactive game.

FIG. 11 illustrates an implementation of an embodiment of the present invention as a mass audience interactive game.

### DETAILED DESCRIPTION OF THE INVENTION

### Definitions

The term “tracking” and other grammatical variants thereof, generally refer to the direct or indirect detection of movement of one or more objects, including but not limited to detecting the location, position, speed, and acceleration of objects, or identifiers associated therewith at a given point or period in time. The tracking of objects may be in real-space and real-time, or by way of a virtual representation of one or more objects or by processing an image or volumetric element, or data representative of the image or volumetric element such as pixels or voxels.

The term “responsive” is used to define an interaction of an object or material with electromagnetic energy. For example, responsive can be used to define a passive interaction or an active interaction or a combination thereof. An active interaction can be representative of an object being impinged by a first set of one or more frequencies of electromagnetic energy and emitting a second set of one or more frequencies of electromagnetic radiation. In addition, a passive interaction can be representative of an object being impinged by a first set of one or more frequencies of electromagnetic energy and emitting electromagnetic radiation of substantially the same frequencies. Other forms of active interaction and passive interaction would be readily understood by a worker skilled in the art.

The term “target” is used to define a person, animal, vehicle, box or other object as would be readily understood or groupings or sets of objects. In accordance with the present invention, a target is an object that the tracking thereof is required.

As used herein, the term “about” refers to a +/−10% variation from the nominal value. It is to be understood that such a variation is always included in a given value provided herein, whether or not it is specifically referred to.

Unless defined otherwise, all technical and scientific terms used herein have the same meaning as commonly understood by one of ordinary skill in the art to which this invention belongs.

The object tracking system according to the present invention is configured to track the movement of a plurality of targets, wherein the detected movement of the plurality of targets is used for the modification of an interactive environment. The system comprises one or more imaging devices, wherein each imaging device is configured to capture two or more images of at least some of a plurality of target identifiers, wherein each target identifier is associated with one or more of the plurality of targets. Furthermore, each of the target identifiers is responsive to electromagnetic energy. For example, each image can be representative of the location of each of the captured target identifiers. The system further comprises a processing module which is operatively coupled to the one or more imaging devices, and configured to receive and process the two or more images. During the processing of these two images, a first location parameter and a second location parameter for a predetermined region are determined. The one or more movement parameters are at least in part determined from the first and second location parameters. These one or more movement parameters which are determined by the processing module are at in part used for the modification of the interactive environment.

In embodiments, the processing module is configured to enable the selection of a predetermined region for evaluation of a movement parameter associated therewith, wherein the predetermined region can include one or more of the plurality of targets. In this manner, the processing module is able to evaluate a movement parameter based on a defined portion of an image, an entire image or a combination one or more portions or full images. As such, the processing module can determine a movement parameter reflective of the movement of one or more of a plurality of targets.

In embodiments of the present invention, the object tracking system is configured to track and/or evaluate movement of the plurality of targets in one or more directions. For example, movement can be determined to be generally in one of two directions, or generally in one of four directions. For example, movement can be tracked as being generally one dimensional for example, either left or right, or generally either up or down. In other embodiments, movement can be tracked as being generally left, right, up or down. In some embodiments, movement can be tracked substantially as a vector in a 2-dimensional space, or as a vector in a 3-dimensional space. Depending on the desired format of the movement tracking, appropriate images are to be captured in order to enable the evaluation of a suitable movement parameter.

In some embodiments, the object tracking system is configured for operation in a spectator venue, for example an arena, theatre, sports field and the like. In these embodiments, the plurality of targets, namely spectators at the venue, are pre-assigned physical locations as defined by the venue itself, for example sections, rows and seats. In this type of operational environment, the object tracking system is configured to track the collective movement of a plurality of targets in a predetermined region, for example a section. Upon evaluation of the collective movement, the one or more processing modules, based at least in part on the determined collective movement of the plurality of targets and the known configuration of the venue, for example the rows and seats associated with the section under consideration, are configured to interpolate the movement of the individual targets. In this manner, the movement of the individual targets can be assessed, without the need for the individual tracking of each of the targets.

In some embodiments, the intensity of light reflected from the targets or target identifiers may be used to track the motion of the targets and/or target identifiers. For example, the captured images may be processed to measure the intensity of light at different points on grid and changes in the intensity pattern may be analyzed to obtain information about the movement of the targets in one or more predetermined areas. Exemplarily, algorithms such as optical flow algorithms may be used to analyze the intensity patterns.

In embodiments of the invention, the processing module is further configured to generate one or more control signals which can be uses for operational control of a software application, which is configured to provide the interactive environment. The processing module is configured to generate these one or more control signals based at least in part on the one or more movement parameters, which are based at least in part on the movement of the plurality of targets. For example, in some embodiments, the interactive environment can be presented to a plurality of people using a visual display system or an auditory system, wherein movement of the plurality of people is at least in part used to control what is presented to the plurality of people.

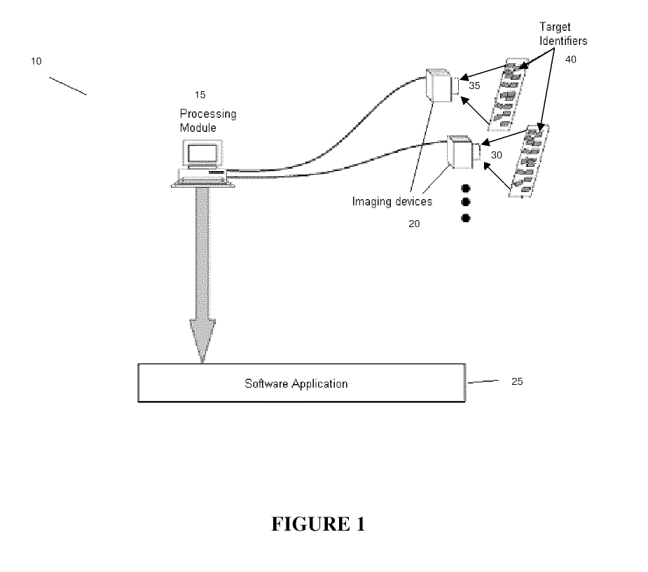

FIG. 1 illustrates a schematic representation of the object tracking system 10 according to embodiments of the present invention. The system comprises one or more imaging devices 20, wherein each of these imaging devices 20 are configured to capture 30, 35 two or more images of at least some of a plurality of target identifiers 40. For example, an image captured by an imaging device can depict a reflection or emission of electromagnetic energy by the target identifiers, thereby providing an indication of the location of the target identifiers and the one or more targets associated therewith. These captured images are used by the processing module 15, to evaluate the movement of targets. Information indicative of the movement of the targets, as determined by the processing module 15, is used at least in part to provide control signals to a software application 25 for operational control thereof. In this manner, the software application 25, for example a gaming environment, can at least in part be controlled by the movement of the targets.

In some embodiments, the processing module is configured to identify a target identifier, and subsequently determine a first location of the identified target identifiers at a first time interval. The processing module can be further configured to determine a second location for the identified target identifiers at a second time interval. In response to the determined first and second locations of the identified target identifiers, the processing module can determine a relative difference between the first and second locations in order to determine location and movement information of the one or more targets.

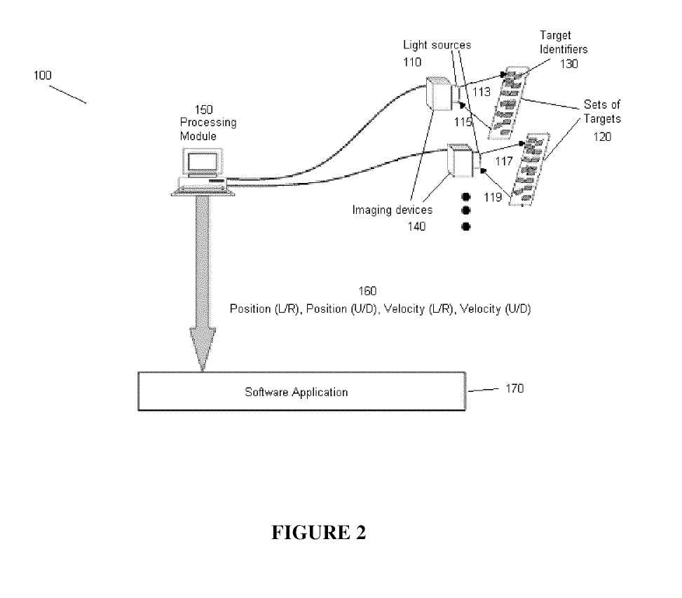

FIG. 2 illustrates an object tracking system 100 according to embodiments of the present invention. The light sources 110 are configured to emit first electromagnetic energy 113 and 117 towards the sets of targets 120, wherein each target has associate therewith one or more target identifiers 130. The first electromagnetic energy 113 and 117 impinges on the target identifiers and the target identifiers are responsive to first electromagnetic energy 113 and 117 with second electromagnetic energy 115 and 119 respectively. In some embodiments, the target identifiers are passive, for example, the target identifiers are configured as reflectors or the like, wherein the one or more frequencies of the first electromagnetic energy are substantially the same as the second electromagnetic energy. In some embodiments, the target identifiers are active, for example the target identifiers are configured as conversion elements such as phosphor, quantum dots or the like, wherein the one or more frequencies of the first electromagnetic energy are substantially different from those of the second electromagnetic energy.

The system 100, further includes imaging devices 140, which are substantially aligned with the light sources 110. In other embodiments, a light source and an imaging apparatus are not substantially aligned. The imaging devices are configured to capture the second electromagnetic energy 115 and 119 and thereby form one or more images representative of at least some of the target identifiers. The processing module 150 is operatively coupled to the imaging devices 140 and receives the one or more images. The processing module is configured to determine a position and velocity 160 associated with the captured target identifiers.

In some embodiments, the processing module is configured to generate one or more control signals for a software application 170, wherein the one or more control signals are generated at least in part based on the determined position and velocity associated with the captured target identifiers.

### Target Identifiers

The one or more target identifiers associated with each of the plurality of targets is an object or identifier that can be identified in the images captured by the one or more imaging devices. In some embodiments there may be multiple target identifiers associated with each target. The target identifiers are the formations that the imaging devices capture to drive the object tracking system.

In some embodiment of the present invention, a target identifier is the target itself as a whole, or a portion thereof. For example, in some embodiments the movement of a plurality of people in an arena setting is desired. In this embodiment, each target can be a particular individual, wherein that individual or a portion thereof acts at the associated target identifier which is responsive to electromagnetic energy.

In embodiments of the invention, the target identifiers are responsive to the electromagnetic energy in either a passive or active manner. For example a passive response by a target identifier means that the target identifier itself is substantially passive in its response to the electromagnetic energy, for example reflection. In addition, an active response implies that the target identifier is active in its response to the electromagnetic energy, for example the target identifier absorbs a first frequency or frequency range of electromagnetic energy and as a result of this absorption, emits the same or a different frequency or frequency range of electromagnetic energy.

In some embodiments, a passive response by the target identifiers can be, for example, the reflection, refraction or diffraction of the electromagnetic energy. For example, specular reflection occurs when the electromagnetic energy is emitted toward a very smooth reflective surface, for example, a mirror. One can determine the direction of reflection when there is specular reflection from an object. The imaging devices can be configured to receive the specular reflection of the electromagnetic energy from the target identifiers. Diffuse reflection occurs when the electromagnetic energy is emitted toward a rough surface. This reflection can be used to reflect the electromagnetic energy in a plurality of directions. Retro-reflection occurs when the surface reflects the electromagnetic energy substantially back in the direction from which it came. A worker skilled in the art would readily understand that retro-reflection can be a form of specular reflection or diffuse reflection or a combination of diffuse and specular reflection

A worker skilled in the art would readily understand that using different types of materials, such as, mirrors, metal, glass, and the like, and different shapes, for example, concave, convex, spherical and the like, for the surface of the target identifier, would create different reflections when electromagnetic energy is emitted toward the surface. In one embodiment of the present invention, the target identifiers may be configured to respond to the electromagnetic energy by reflecting the energy in the direction of the imaging devices.

In some embodiments, the target identifiers may be actively responsive to the electromagnetic energy. An active response by the target identifier means that the target identifier itself does something in response to the electromagnetic energy and emits a response. An active response may include, but is not limited to, converting the electromagnetic energy received by the target identifier into another type of energy and emitting the resulting energy. In some embodiments, a target identifier can comprise a phosphorescent or quantum dot type material, wherein the target identifier may be configured to absorb certain frequency ranges of the electromagnetic energy, and emit the remaining frequency ranges. In some embodiments, the target identifier may be configured to react to a particular frequency range by shifting the wavelength of the electromagnetic energy received and emitting an electromagnetic energy within a different frequency range.

In further embodiments, the target identifiers may be the source of the electromagnetic energy, for example, the target identifier is a light source. In these embodiments, the target identifiers may be used in a light-deprived environment to emit the electromagnetic energy that is captured by the imaging devices. In one embodiment, the target identifiers may be but are not limited to cell phone lights, lighters, flashlights, or the like which emit the electromagnetic energy.

In some embodiments of the present invention, the target identifiers are configured in order to enable identification thereof. In this manner during the processing of an image, the target identifiers of interest can be identified within the image, thereby for example enabling the tracking of a specific target identifier.

The target identifiers may also be one or more of a number of different forms for example, different shapes, sizes, colours and within each form of a target identifier there may be one or more distinguishable features or elements. The colour of light emitted or reflected by a target identifier can be captured by an imaging device, wherein this colour can be a result of the type of response, i.e. passive or active, of the target identifier to electromagnetic energy. In addition, the colour of light emitted from a target identifier can be affected by the conversion or absorption of the electromagnetic energy. In some embodiments, the target identifiers may be fitted with a light filter and/or a substance or material that may convert or absorb certain electromagnetic energy frequency ranges. By including a filter with the target identifiers, the processing of the images of the target identifiers captured by the imaging devices may be controlled at least in part based on the anticipated electromagnetic energy frequencies indicative of the target identifiers, which may aid in the reduction of errors caused when processing images which include objects or forms that are not target identifiers.

In some embodiments, target identifiers are different colours. Each target identifier may be configured differently to emit, convert, absorb or reflect different frequency ranges. The imaging devices can be configured to capture the images of the different coloured target identifiers. The processing module may subsequently differentiate between the colours of the target identifiers for identification and/or evaluation of the location and/or movement of a target identifier and its associated target.

The target identifiers may also be configured in one or more of a variety shapes. Shapes of target identifiers may include, but not limited to, circles, squares, rectangles, polygons, triangles, ovals, semicircles, ellipses, or the like. It would be known to a worker skilled in the art that certain shapes can be used to provide certain information for use by the processing module. For example, if the object tracking system is to track the rotational movement of the target identifiers, circles or squares or equilateral triangles may not be appropriate shapes as rotation of this format of a target identifier may not be accurately determined due to symmetries.

In some embodiments of the present invention, the target identifiers may be configured in the form of a consumer product or a consumer product symbol. The imaging devices would capture the different shaped target identifiers and the processing module would measure and compare the shape of the objects with predetermined values to determine which shape the target identifier represents, and subsequently, which consumer product the target identifier represents. In some embodiments, the target identifiers may be representative of product branding, service branding or other formats of branding as would be readily understood by a worker skilled in the art.

In some embodiments, the size of the target identifiers may be used to differentiate the target identifiers from other objects which may be captured by the imaging devices. For example, the size of the target identifier can be determined by the processing module and compared to predetermined values thereby enabling the determination of whether the object captured by the imaging device is a target identifier.

In some embodiments, the target identifiers comprise a background including a flat card stock with a retro-reflective material bound to the card stock. Retro-reflective materials which may be used as target identifiers, include, but are not limited to, adhesive tape, paint, ink or fabric. Possible self-adhesive tapes that may be used include, but are not limited to 1.5″ wide silver retro-reflective tape, 1″ wide extra bright silver retro-reflective tape, 3″ wide mid-grade green or silver retro-reflective tape, 1″ wide extra bright USA Department of Transportation-approved silver and red retro-reflective tape.

In some embodiments, the target identifiers can be cut to a 4″×6″ piece of card stock, which is then compared to the predetermined values of the size and shape of the target identifiers within the application of the processing module. Other sizes of target identifiers would be readily understood by a worker skilled in the art.

In another embodiment of the present invention, the target identifiers include a light source. For example, a target identifier can be cell phones which includes an illuminated screen. This configuration of a target identifier may be suitable for use in a light-deprived environment such as, but not limited to, an arena environment where concerts, sporting events, circus performances, rallies, presentations, political events, or the like may be hosted.

In some embodiments of the present invention a target identifier can be configured to be used or worn by a person. For example, a target identifier can at least in part be configured as a flag, cup, hat, T-shirt, pants or other format of clothing as would be readily understood by a worker skilled in the art. As further examples a target identifier can be configured to form at least a part of a pin, broach, clip or the like, which can provide for the ease of attachment to a particular target or item worn by a target, for example the clothing of a person. In some embodiments, target identifiers are provided to a target in the form of a promotional item or souvenir connection with a mass spectator event.

### Source of Electromagnetic Energy

In some embodiments of the invention, the interaction or responsiveness of the plurality of target identifiers with ambient electromagnetic energy is used by the imaging devices for the capturing of images of at least some of the plurality of target identifiers. For example, the ambient electromagnetic energy can be artificial or natural light, thermal energy or the like.

In some embodiments of the instant invention, one or more light sources are used to direct electromagnetic energy generally in the direction of the targets and/or target identifiers. The target identifiers can be responsive to this emitted electromagnetic energy in one or more ways, which can include reflecting the energy or by otherwise emitting electromagnetic energy or signal in response to the electromagnetic energy emitted by the light source. The light source may emit electromagnetic energy that is within the spectrum of visible and non-visible light, including ultraviolet and infrared. The light sources may also include sources of electromagnetic energy that emit energy beyond this spectrum, including gamma rays, x-rays, microwaves and radio waves, or one or more combinations thereof. For example, a light source can comprise one or more broadband light sources and/or one or more narrow band light sources.

In some embodiments, a light source emit electromagnetic energy at one or more predetermined frequencies or frequency ranges generally in the direction of the one or more targets and associated target identifiers. In embodiments a variety of types of light sources as would be known by a worker skilled in the art would be suitable for generation of electromagnetic energy. These light sources, which in embodiments that produce light in the visible or non-visible spectrum, may include one or more of a variety of devices including incandescent and fluorescent lights or lamps, lasers, other photoluminescent, chemoluminescent, fluorescent and phosphorescent light sources, and the like. Other common lighting devices include light emitting diodes (LED) and organic LEDs (OLED) or other semiconductor or non-semiconductor light sources.

In some embodiments, a light source emits electromagnetic energy in one or more of a wide range of frequencies, including but not limited to, radio frequency, the visible light spectrum, the infrared light spectrum, the ultraviolet light spectrum, x-rays and gamma rays or the like, may be used. A worker skilled in the art would recognize that certain portions of the spectrum may not be suitable for some applications, including, for example, when the electromagnetic energy is not suitable for detection due to ambient conditions in the chosen environment, or when the target may be adversely affected by the type of emitted electromagnetic energy. In such cases, for example, those portions of the electromagnetic spectrum which would be suitable may be used.

In some embodiments a light source can include specular emissions, diffusive emissions or both. As would be understood by a worker skilled in the art, specular emissions may be more suitable when the target and/or target identifier is constrained within a known and relatively small location. Conversely, diffusive emissions may be more suitable when the electromagnetic energy is emitted towards a large region and/or the plurality of targets and/or target identifiers are spread out. In some embodiments, multiple specular light sources can be used to cover large areas or regions. In embodiments, some combination of differing types of lights sources may be used.

In some embodiments, light sources may be used in conjunction with optical elements to alter and/or control one or more of a number of characteristics of the electromagnetic energy emitted thereby. The various optical elements associated with a light source of the present invention may, for example, be designed to achieve a desired spatial luminous intensity distribution. A worker skilled in the art will readily understand that the spatial luminous intensity distribution can be affected by the geometric shape and spatial arrangement of the optical elements of the light source. For example, the light source's optical elements may use a diffuse, specular, or semi-specular reflector, using appropriate materials known in the art, (e.g. spun, peened, anodized or electroplated metal, sputtered plastic or glass etc.), to obtain a desired luminous intensity distribution.

As many light sources have beam spread to varying degrees, a light source may incorporate collimating elements, such as are readily known to a worker skilled in the art, to achieve a narrower or wider beam width, as desired, which can enable the increasing or decreasing of coherence and can result in increased visibility or detection capabilities of targets or target identifies with said beam. For example, semiconductor lasers typically have elliptical beam spreads of roughly 30 degrees by 10 degrees. As the radiation is coherent, these beams can be collimated into a beam with much less divergence, such as is done for handheld laser pointers. Examples of collimating elements include but are not limited to spherical, cylindrical lenses and compound parabolic reflectors.

Lasers may be used as the light sources in some embodiments. Lasers produce a coherent light that are well-suited for producing a focused beam of electromagnetic energy in both visible and non-visible portions of the electromagnetic spectrum. In certain embodiments, various optical elements can be used to increase or decrease beam spread and coherence. The general category of lasers includes, but is not limited to gas lasers (e.g. helium-neon laser, carbon-dioxide laser), chemical lasers, metal-vapour lasers, exciter lasers, solid-state lasers (e.g. ruby laser, neodymium laser, titanium-doped sapphire), fibre lasers (e.g. erbium-doped fibre lasers), dye lasers, free-electron lasers and semiconductor lasers. These lasers differ widely in their power levels, efficiency, size, stability and wavelength ranges. A worker skilled in the art would readily understand the type of lasers and wavelength ranges thereof which may be applicable of use with embodiments of the present invention.

In some embodiments of the present invention, filters specific to identified energy frequencies are used in conjunction with a light source to block certain wavelengths of electromagnetic energy and permit only the desired wavelengths to be directed toward the targets and target identifiers. In some embodiments, one or more of the light sources include a filter to block UV light and to allow only the visible light to be directed towards the targets and target identifiers. In some embodiments, all or some of the visible portion of the electromagnetic spectrum may be filtered; for example, where the light source is intended to emit electromagnetic energy that is not optically detectable by people or animals or optionally when a target identifier is responsive to a particular wavelength of light.

In some embodiments of the present invention, the electromagnetic energy emitted from the light source may be encoded using one or more of a variety of modulation techniques, for example, amplitude modulation, phase-shift keying (PSK) or other energy wave encoding techniques that would be known to a worker skilled in the art. The electromagnetic energy can be encoded with information which is then captured by one or more of the imaging devices and translated by the processing module to determine which electromagnetic energy has been reflected from one or more of the target identifiers. Such techniques may be employed in some embodiments to enable the use of electromagnetic energy wavelengths that may be susceptible to interference from ambient conditions, such as sunlight or light from other artificial light sources that are being used by the object tracking system.

These encoding techniques and other methods may be used to reduce signal noise or error, and to provide a more robust system that may be adapted for use in many different environments. These environments include enclosed or indoor locations, outdoor locations in a variety of operational conditions, for example bright sun, rain, cloud, or combinations thereof.

In some embodiments one or more light sources are located proximal to one or more of the imaging devices or other sensing devices. In other embodiments the one or more light sources are located separately and may or may not be linked communicatively with the one or more imaging devices. In addition a light source associated with the optical tracking system may emit electromagnetic energy continuously, intermittently, randomly, periodically or the like. In some embodiments, the emission of electromagnetic energy from a light source occurs only during periods of operation of one or more of the imaging devices and in such cases there may be operative communication between the light source and the imaging device to ensure that the emission of the electromagnetic energy occurs at the desired time. In some cases, the one or more imaging devices and the one or more light sources operate independently according to a pre-determined sequence or cycle.

In some embodiments, the ratio of light sources to imaging devices is 1:1. In other embodiments, there may be only one or relatively few light sources operatively associated with the object tracking system. In some embodiments, the number of light sources is greater than the number of imaging devices.

In some embodiments, the electromagnetic energy emitted by the one or more light sources is intended to be the same energy that is used by the imaging device to track targets, by, for example, being reflected by the target identifiers, namely a passive interaction. In some embodiments, the target identifiers are responsive to the electromagnetic energy emitted by the light sources in an active way, by, for example, emitting a different wavelength of electromagnetic energy in response to the electromagnetic energy emitted by the one or more light sources.

### Imaging Device and Image Analysis

The one or more imaging devices are used to capture images of at least some of the target identifiers. In some embodiments an imaging device captures an image, which may or may not be converted into data representative of that image. In some embodiments, an imaging device is configured to create the representative image data directly without the need to initially create an image.

The one or more imaging devices, in some embodiments, record frames of images at different time intervals. The images may be captured at time intervals which are pre-determined time intervals, or captured according to instructions received from one or more communicatively linked processing modules. In some embodiments, these instructions are provided by the one or more lighting devices, when said lighting devices are associated with the optical tracking system. In cases where one or more light sources are associated with the system and wherein the time intervals are pre-determined, the one or more light sources are operational at the time intervals of image capture by an imaging device.

The use of multiple imaging devices provides the capability to capture multiple views or images of a desired area or region simultaneously or sequentially, thereby enabling the capturing of three-dimensional or depth images, or panoramic images. Multiple imaging devices used to capture the same or substantially the same target identifiers from different angles can provide additional measurable data from which to assess various characteristics of the location and/or movement of the target identifiers.

In some embodiments of the present invention, an imaging device is a camera configured to capture the images of the target identifiers according to reflected or emitted visible and/or non-visible light. In some embodiments, different types of imaging devices which may be responsive to different forms of electromagnetic energy other than the ultraviolet, visible and/or infrared portions of the electromagnetic spectrum.

In some embodiments, various elements may be used in conjunction with the imaging device to alter or control the effects of received electromagnetic energy. For example, various filters may be employed in order to block out certain wavelengths or types of electromagnetic energy. These various elements, including filters and other elements known to a worker skilled in the art, may be used to assist in discriminating the energy received at an imaging device, for example, enabling the identification of energy which comes from target identifiers from energy from other sources. This type of energy discriminating may result in the reduction of “noise” in the image. As such, these filters and other various elements may be used to improve signal-to-noise ratios.

In some embodiments, the imaging device may be configured to process and/or recognize a digital signal encoded in the energy received from a target identifier, which may or may not be the same energy reflected by the target identifier. In embodiments employing encoded signals in the received electromagnetic energy, the encoded signal may be used to discriminate between the energy from the target identifiers and ambient energy. It may also be used to discriminate between target identifiers by, for example sending certain encoded signals in certain wavelengths that may be reflected by one or more of a first group of target identifiers and absorbed by other groups, while different encoded signals may be absorbed by the first group and reflected by other groups. This and other techniques could be employed to uniquely identify individual target identifiers, or identify one or more target identifiers as belonging to a particular group.

In some embodiments of the present invention, where the object tracking system includes more than one imaging device used to capture images of the target identifiers, the multiple images from the separate imaging devices may be combined together using “image stitching” thereby enabling the creation of an aggregate image from multiple images. Information from aggregate or stitched images can provide information about the target identifiers individually or as a collective group. Use of a stitched image can provide a way of mapping a three-dimensional space into two-dimensions and as such a two-dimensional coordinate system can be used to represent data taken from three-dimensions. For example, image stitching generally refers to the combining or addition of multiple images or volumetric elements taken from sensing or imaging devices having overlapping, adjacent, or near-adjacent fields of view to produce a segmented image or volumetric element. Imaging stiching may enable the creation of a single panorama of a plurality of images. In additon, imaging stiching may also refer to the combining or addition of multiple data sets which represent an image or volumetric element.

In embodiments of the invention, electromagnetic energy detected by the imaging device can be associated with particular coordinates, which represent the location of the target identifier at a given time. By analyzing multiple images, the characteristics of location, movement, and orientation of the one or more target identifiers can be assessed as a function of time. In some embodiments, each of the target identifiers are assessed individually and in others embodiments aggregated target identifiers can be assessed as a group.

Images, whether a single image or a stitched image formed from multiple images, can be used to measure and collect information about individual target identifiers and/or groups of target identifiers. This information may or may not be aggregated at a later time to provide information about group characteristics, including but not limited to magnitude of change in position, velocity and acceleration of motion of the group as a whole or an average thereof. In some embodiments, the image or images may be used to only measure aggregated characteristics of the movement, location and orientation of a group or groups of target identifiers.

In some embodiments of the present invention, the imaging device captures at least one target identifier within a captured image. In embodiments, the imaging device captures at least some pre-determined threshold number of the identified target identifiers within a particular image. The pre-determined threshold number may be set by an administrator or user of the system, and may include a percentage of the total targets (such as 10%, 40%, 50%, or 100%, or the like as specified) or a specified number of target identifiers. This predetermined threshold may be dynamic or static during the one or more uses of the system.

In some embodiments of the invention, the system comprises 8 imaging devices, each being a 640×480 camera with a speed of 49 Frames per second, which results in approximately 49 Mbytes/sec of data. This configuration of an imaging device can provide a means for capturing a total of approximately 400 target identifiers, based on a resolution of 1 inch per pixel.

In embodiments of the invention, the system comprises 8 imaging devices, each being a 1024×768 camera with a speed of 10 Frames per second, which results in approximately 62 Mbytes/sec of data. This configuration of an imaging device can provide a means for capturing a total of approximately 1000 target identifiers, based on a resolution of 1 inch per pixel.

In some embodiments of the invention, the system comprises 4 imaging devices, each being a 2048×2050 camera with a speed of 10 Frames per second, which results in approximately 167 Mbytes/sec of data. This configuration of an imaging device can provide a means for capturing a total of approximately 5000 target identifiers, based on a resolution of 1 inch per pixel.

### Processing Modules

One or more processing modules are communicatively linked to the one or more imaging devices and are used to translate the images captured by the imaging devices into control signals to be input into an interactive environment enabling control thereof. In particular, the one or more processing modules are configured to receive the two or more images from the one or more imaging devices. By processing these two or more images, the one or more processing modules are configured to establish a first location parameter and a second location parameter for a predetermined region, wherein a predetermined region includes one or more of the plurality of target identifiers being tracked. Subsequently, the one or more processing modules are configured to determine one or more movement parameters which are based at least in part on the first location parameter and the second location parameter, wherein the one or more movement parameters are at least in part used for the determination or evaluation of the control signals for input into the interactive environment.

In some embodiments of the present invention, movement of the targets/target identifiers within a predetermined region is determined using an optical flow algorithm. For example, the captured images may be processed to measure the intensity of light at different points on a grid and changes in the intensity pattern may be analyzed to obtain information about the movement of the targets/target identifiers in one or more predetermined areas. A worker skilled in the art would readily understand the types of optical flow algorithms which may be used for this evaluation of movement.

In some embodiments, the one or more processing modules are configured to evaluate the movement of the targets/target identifiers by the comparison changes in thermal signatures. This configuration of the processing system may be applicable in darkened environment, wherein the targets and/or target identifiers are responsive to thermal radiation. In these embodiments, the evaluation of the changes in thermal gradients can provide a means for the determination of the movement within the predetermined region.

In some embodiments of the present invention, the one or more processing modules are configured to evaluate the movement of the targets/target identifiers by the use of stereo-vision, which can enable the assessment of the movement of the plurality of targets/target identifiers within a 3-dimensional space. A worker skilled in the art would readily understand how to implement this type of image analysis in order to evaluate the movement.

In some embodiments of the present invention, the one or more processing modules are configured to receive two or more images from the one or more imaging devices, identify one or more target identifiers within said at least one image, establish a first location parameter for each of the target identifiers identified, establish a second location parameter for each of the target identifiers identified, determine one or more movement parameters based at least in part on the first location value and the second location value. The one or more processing modules are further configured to modify an interactive environment based at least in part on the one or more determined movement parameters.

In some embodiments of the invention, the one or more processing modules are configured to generate the one or more control signals based at least in part on the one or more difference location values, wherein these control signals are used for the modification of the interactive environment.

According to embodiments of the present invention, the one or more processing modules are configured to enable the determination or assignment of one or more predetermined regions which referenced during the evaluation of the one or more movement parameters. In some embodiments, a predetermined region encompasses an entire location wherein the tracking of the plurality of targets is required. In some embodiments, a predetermined region defines a portion of the entire location. The division of an entire location into two or more predetermined regions can be defined arbitrarily or according to a known or predefined plan of the entire location. For example, in some embodiments the entire location is represented by an arena or auditorium, wherein these types of venues are typically sectioned according to a predetermined seating plan. In these embodiments, the predetermined regions can be directly or partially defined by the predetermined seating plan.

In some embodiments, a predetermined area can be defined such that each predetermined area is associated with a limited or predetermined number of targets and/or target identifiers. In these embodiments, the selection of the predetermined area can provide a means for the tracking of an individual target.

In some embodiments of the present invention a plurality of interconnected processing modules are employed in the object tracking system, wherein each of these processing modules is assigned one or more predetermined tasks. By modularizing the variety of tasks provided by the one or more processing modules, when an improvement or modification of a particular task or processing module, interchangability of said “improved” module is possible, without the need for replacement or modification of all of the one or more processing modules.

For example, in some embodiments, there are a plurality of interconnect processing modules, wherein a first processing module is responsible for interfacing with one or more of the imaging devices, wherein this processing module is configured to receive the images from the one or more imaging devices and convert these images into a digital format, subsequently saving this digital format of the images into a database, for example. A second processing module is configured to provide a communication interface between the plurality of processing modules thereby providing a means for managing the transfer of data between the processing modules. A third processing module is configured to provide the ability to divide or separate a venue into one or more predetermined regions. A further processing module is configured as a threshold evaluation tool, wherein this module provides a means for selection of a predetermined region and further for enables the normalization of the collected data for the predetermined region. An additional processing module can be configured to provide the interactive environment, and is responsive to the one or more control signals generated by the one or more processing modules for control thereof. Other processing modules are configured to provide modifications of the interactive environments and partial or total operational control one or more components of the object tracking system.

The one or more processing modules can be configured using operatively connected general purpose computing devices, microprocessors, dedicated hardware processing devices or other processing devices as would be readily understood by a worker skilled in the art. In some embodiments of the present invention, the operational functionality of the one or more processing modules can be provided by a single processing device. The processes performed by the one or more processing modules can be represented by specific hardware, software, firmware or combinations thereof associated with the one or more processing devices.

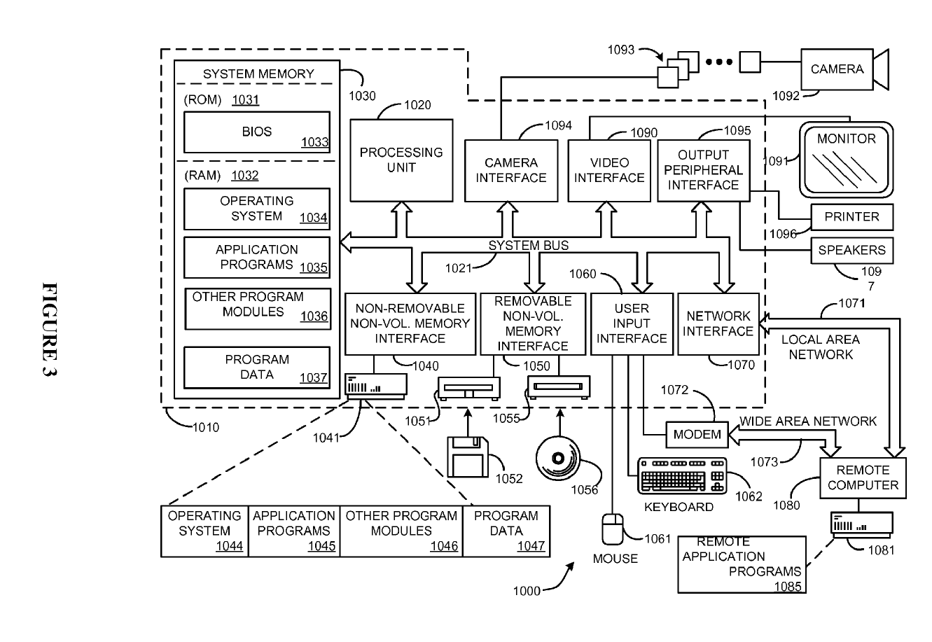

With reference to FIG. 3, the one or more processing modules 1000 can be made up of numerous general purpose or special purpose computing system environments or configurations, including but not limited to, personal computers, server computers, hand-held, laptop or mobile computer or communications devices such as cell phones and PDA's, multiprocessor systems, microprocessor systems, network PCs, minicomputers, mainframe computers, distributed computing environments that include one or more of the above systems or devices, or other processing device configuration as would be readily understood by a worker skilled in the art. In some embodiments, the processing module can be described in the context of computer-executable instructions being executed by a computer.

Components of a computer may include but are not limited to a processing unit 1020, a system memory 1030, and a system bus 1021 that couples various system components including the system memory 1030 and the processing unit 1020. A computer system memory 1030 can include, but is not limited to RAM, ROM, EEPROM, flash memory or other memory technology, CD-ROM, digital versatile disks (DVD) or other optical disk storage, magnetic cassettes, magnetic tape, magnetic disk storage, or other magnetic storage, or any other medium which can be used to store the desired information and which can be accessed by the computer. The processing unit 1020 may also include, as an input device 1060, one or more imaging devices 1092, such as a camera, capable of capturing a sequence of images. The images from the one or more imaging devices 1092 are input to the processing module via an appropriate imaging device interface 1094. This interface is connected to the system bus 1021, thereby allowing the images to be routed to and stored in the computer system memory 1030.

In some embodiments, the processing module 1000 may operate in a networked environment using logical connections to one or more remote computers 1080. The logical connections may include but are not limited to a local area network (LAN) 1071, or a wide area network (WAN) 1073, such as the Internet.

In some embodiments, the processing module 1000 may output the captured images or the resulting measurements or calculations to a monitor 1091 through an appropriate video interface 1090. The processing module 1000 may also output the control signals to a networked printer 1096 or audio control 1097 through an appropriate output peripheral interface 1095.

In some embodiments of the present invention, where the system includes more than one imaging device used to capture images of the target identifiers, the images from the separate imaging devices are stitched together using “image stitching” to gather information about the collective target identifiers.

In embodiments of the present invention, the processing module is configured to process a digital signal encoded in the energy emitted from the light source. In this embodiment, wherein some encoding technique, such as but not limited to, phase-shift keying (PSK), amplitude modulation, frequency modulation, or the like, is used to encode the electromagnetic energy emission. In one embodiment, the processing module matched filtering in order to more easily identify a signal received from the one or more target identifiers in the presence of noise. A matched filter would be known to a worker skilled in the art to be used with telecommunication signals. A matched filter is obtained by correlating a known signal or template with an unknown signal to detect the template in the unknown signal. The processing module can be used to compare the signal received from the one or more target identifiers with a predetermined template to determine whether the target identifier is emitting a known signal which can be identified.

The present invention may be further described to include one or more systems herein described connected via an Internet connection wherein the control signals from two or more separate system locations can be used to control a software application providing the interactive environment.

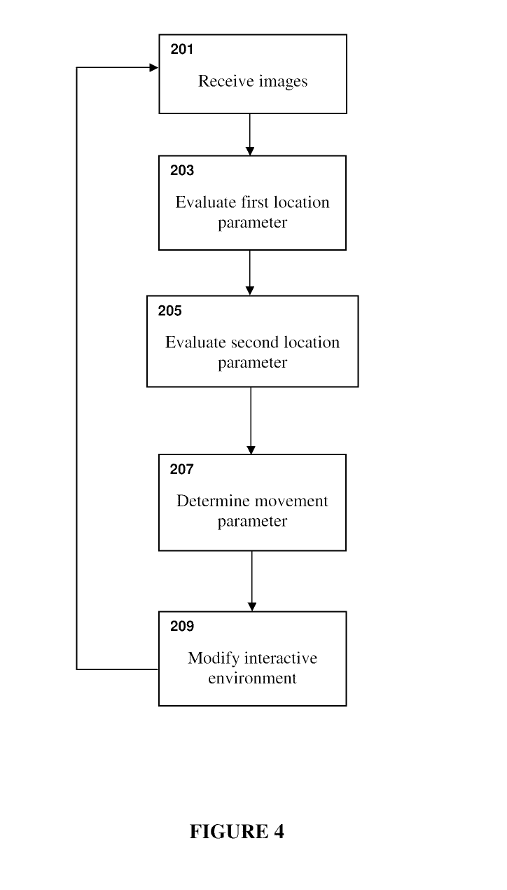

In some embodiments of the present invention, and with reference to FIG. 4, the one or more processing modules are configured to receive data 201 indicative of the two or more images capture by the one or more imaging devices. The one or more processing modules subsequently determine a first location parameter 203 for a predetermined region, wherein this predetermined region includes one or more of the plurality of target identifiers. The evaluation of the first location parameter can be based at least in part on a first image of the two or more images. The one or more processing modules are then configured to evaluate a second location parameter 205 associated with the predetermined region, wherein this second location parameter can be evaluated at least in part based on a second image of the two or more images. Based at least in part on the first and second location parameters, the evaluation of one or more movement parameters 207 associated with the particular predetermined region is made. The movement parameter can be representative of the overall movement of the plurality of target identifiers/targets within the predetermined region. The one or more processing modules subsequently evaluate one or more control signals for modification of the interactive environment 209. This evaluation of the one or more control signals is based at least in part on the one or more movement parameters. In this manner, the tracking of movement of a plurality of targets, provides a means for at least partial control of the interactive environment by the targets.

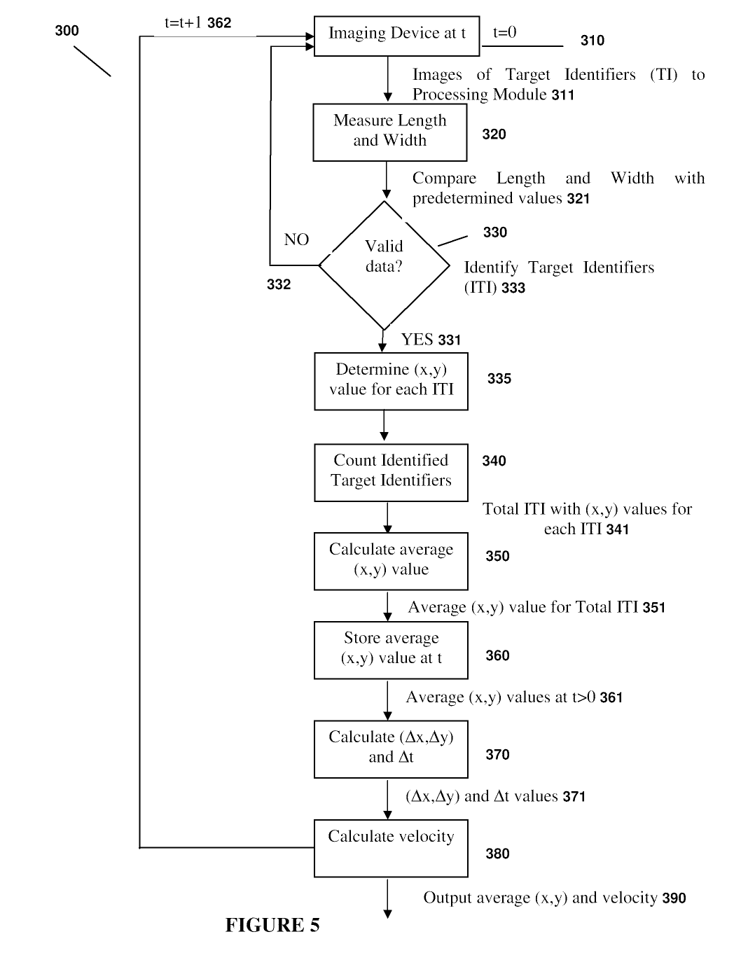

In one embodiment of the present invention, as illustrated in FIG. 5, the processing module receives one or more captured images 311 from the one or more imaging devices at a first time point (t=0) 310. The processing module identifies the one or more target identifiers by measuring the length and width of each target identifier captured in the one or more images 320. The processing module further identifies the one more target identifiers by calculating the surface area of each target identifier. The processing module determines that each target identifier is an acceptable target if the length and width, and therefore, if the surface area is within +/−10% of the predetermined size for the target identifiers 321 and 330. The processing module may also determine the orientation of the target identifiers by determining whether the target identifier has been rotated within +/−30 degrees of the predetermined rotational value. The processing module identifies the (x, y) location of each of the identified target identifiers 335. The processing module then counts the number of identified target identifiers 340, i.e. those target identifiers that meet the above-noted criteria 331, to determine the total number of identified target identifiers. The processing module calculates the average (x, y) location of all identified target identifiers at t=0 350. At a second time point (t>0), the processing module receives one or more images from the one or more imaging devices 320, identifies all captured target identifiers 320 to 330, counts the number of identified target identifiers 340, and calculates the average (x, y) location of all identified target identifiers at t>0 340. The processing module calculates the difference between the average (x, y) location of the identified target identifiers at t=0 and at t>0 to determine the change in location (Δx, Δy) for the change in time Δt 370. By calculating the change in location and the change in time, the processing module can calculate the velocity 380 of the identified target identifiers. The processing module sends, as output, an average (x, y) location and the velocity of the identified target identifiers to be used as an input which is or facilitates the generation of control signals for a software application 390.

### System Applications

In some embodiments of the present invention, the system described herein can be used to market or advertise consumer products. The target identifiers may be provided to the targets, who, in this embodiment, are an audience within an arena or stadium for a sporting event, concert, or other mass spectator gathering. The target identifiers may be, for example, in the form of a product manufactured by the sponsor or a company advertising their products to the audience. The target identifiers may also comprise retro-reflective material that is in the shape of the sponsor's trademark or known symbol representing their products. The target identifiers may be items that the audience can keep after the event which could provide further advertisement and serve as a souvenir connecting the audience to the event experience after the event is concluded. A system according to the present is used to capture the movement of the target identifiers by the audience. At some point or points during the event the audience is asked to move the target identifiers left and right and/or up and down. The audience is split into one or more teams associated with a gaming application that is shown on the screen or screens within the arena or stadium. The gaming application may also be sponsored by the company providing the target identifiers. The gaming application may be, for example, two race cars of different colours that will race against each other, each advertising a car brand. The two or more teams formed from the audience move their target identifiers, which may also be different coloured cars, which controls the speed of the corresponding car on the gaming application. The audience is then interacting with the gaming application provided by the sponsor.

In some embodiments of the present invention, the system described herein can be used to control effects at an event, such as but not limited to a concert. This embodiment considers the effect of a light-deprived environment. In an arena concert setting, low light levels are required. In this embodiment, the target identifiers themselves can become the light source, emitting electromagnetic energy in the direction of the imaging devices. The principles and method of the described embodiments of the present invention remain the same. The target identifiers and the processing module change accordingly. The imaging devices capture the images wherein the target identifiers emit an electromagnetic energy. The processing module receives the captured images and compares the captured electromagnetic energy to predetermined values to identify the target identifiers. The processing module measures and calculates the positions and velocity of the identified target identifiers to determine movement values. The movement of the target identifiers can be used to control the special effects of the concert or a gaming application shown on a screen or screens of a concert.

In embodiments, the system according to the present invention can be used in an outdoor setting. In these embodiments, some adjustments to the lighting, capturing, and target identifiers may need to be considered due to the existence of a relatively large amount of ambient light, for example light emitted by the sun. Ambient light can increase the noise within the system and can inhibit the detection and measuring of the target identifiers by the processing module. For example, the imaging devices could capture ambient light reflected, or emitted from other objects that are not the target identifiers, which may cause errors in the measuring and calculating of position and velocity information. The system needs to be tailored to block out a desired amount of the ambient light in order to reduce the “noise”. According to some embodiments various techniques may be employed in order to increase the “signal to noise” ratio. These techniques can include: filtering techniques to filter out a portion of the full spectrum of light. The imaging devices may be fitted with light filters that filter out all the ambient light except a specified colour or wavelength of light. The target identifiers may be created to reflect or emit only a particular colour or wavelength. Directional imaging devices may be used to substantially eliminate the affect the ambient light has on the imaging device. Using a directional imaging device will allow only the light coming from a particular direction to be captured. The light sources may be associated with an encoding mechanism so that the processing module will filter out noise in the system, by using for example, matched filtering of the captured electromagnetic energy received from target identifiers with the encoded electromagnetic energy emitted by the light source. The processing module may be operatively coupled with the light source so it can control the encoding of the light being emitted from light source, and what is identified from the captured images. The processing module may also use a match filter to identify a particular signal from the target identifiers which would substantially eliminate errors due to ambient light noise.

In some embodiments, the system according to the present invention is used to track movement of one or more participants at a mass spectator event. In this embodiment, the one or more participants are suitably identifiable by the one or more targets identifiers associated therewith. In this manner, at a mass spectator event, wherein a plurality of individuals may be present, the movement of the one or more participants can be tracked.

In some embodiments, the system according to the present invention can be used to provide a crowd of participants at a mass spectator event with an interactive experience. The movement of one or more participants may be captured by the imaging devices and provided to the processing module to calculate the movement of the one or more participants. In some embodiments, the resulting movement values can be used at least in part to generate one or more control signals which may be used to control an interactive application or environment, such as but not limited to, a gaming application, thereby providing the one or more participants with the interactive experience of controlling the gaming application at least in part through the movement of the one or more participants.

In some embodiments, the interactive applications that may be controlled by the movement of one or more participants include but are not limited to, single player applications, for example, the one or more participants versus the software application; multiplayer applications, for example, two or more participants against each other; or massive multiplayer applications, for example, a plurality of participants versus each other. In some embodiments, the interactive applications may include but are not limited to racing games, battle games, or other interactive applications as would be readily understood by a worker skilled in the art.

In some embodiments, the interactive environment controlled by the one or more participants can be a skill or knowledge based interactive application, a chance based application, or a combination thereof, such as but not limited to, a trivia game or a poker game. In some embodiments, the interactive environment may be competitive, cooperative, narrative, evolutionary, or role-based environments. In some embodiments, the interactive environment may include but is not limited to controlling what is being displayed, for example by having the one or more participants indicate what application is to be applied and what format is to be displayed.

In some embodiments of the present invention the system is configured to provide a mass spectator experience to a plurality of individuals. The system is configured to track the movement of one or more participants wherein the movement of these participants is used at least in part to generate one or more control signals for an interactive environment. In some embodiments, the one or more participants are selected from the plurality of individuals, however the actions of the non-selected individuals may also indirectly or directly generate a reaction from the one or more participants, for example, movement of the one or more participants, thereby providing one or more of the plurality of non-selected individuals with a substantially indirect manner in which to manipulate the interactive environment. For example, a non-selected individual can instruct a participant to move in a particular direction, wherein this movement of the participant is used at least in part for the generation of control signals for manipulation of the interactive environment. In some embodiments, a non-selected individual may be a spectator and as such not have direct or indirect control over the interactive environment or a participant.

In some embodiments of the present invention, the interactive environment is representative of one or more brands. For example, if the interactive environment is a car racing application, there can be different car brands directly associated with the interactive environment.

The invention will now be described with reference to specific examples. It will be understood that the following examples are intended to describe embodiments of the invention and are not intended to limit the invention in any way.

### EXAMPLES

### Example 1

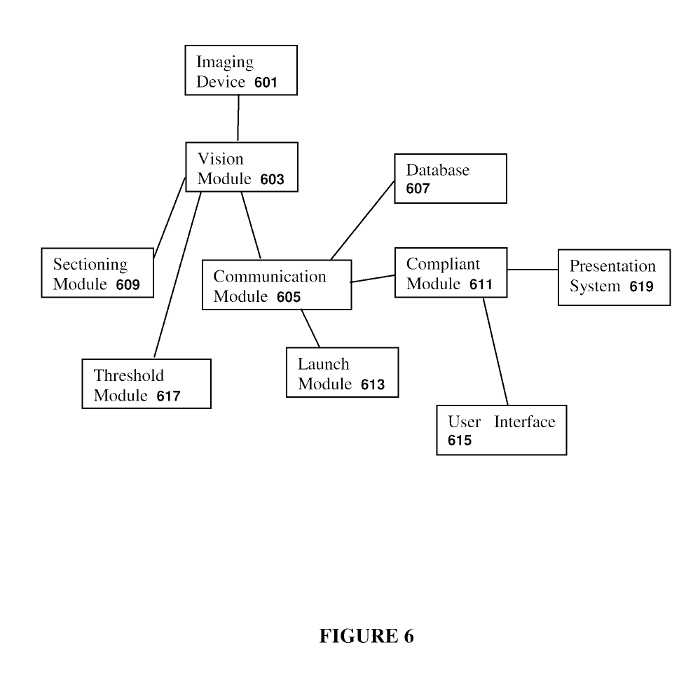

In some embodiments of the present invention, the object tracking system can be configured as illustrated in FIG. 6. The object tracking system includes an imaging device 601, a vision module 603, communication module 605, sectioning module 609, threshold module 617, user interface 615, database 607 and compliant module 611. The object tracking system is operatively coupled to the presentation system 619, which may or may not be a component of the system itself. In some embodiments, the presentation system 619 is provided by a third party. Depending on the implementation of the object tracking system, the system optionally includes a launch module 613. Each of the above modules is further defined below in accordance with some embodiments of the present invention.

### Vision Module 603

Each imaging device is in communication with a separate vision module. This configuration can take advantage of multi-threading capabilities of a suitably configured computing device and can also ensure that the object tracking system remains functional if one of the imaging devices fails. The vision module communicates with the imaging device using the ActiveGigE Software Development Kit (SDK) by A&B Software, however other communication protocols can be used and would be readily understood by a worker skilled in the art. The vision module is used to perform the following functions: select the desired imaging device, specify the width, height, binning properties and format of the acquired images, acquire images from the selected imaging device and save video (as image files) from the selected imaging device.

An object tracking system can include a plurality of vision modules. All of the vision modules, namely one for each imaging device in the optical tracking system, record their motion information to an aggregated database and it is the responsibility of each vision module to ensure that it does not interfere with the read/write processes of any other module or the communication module.

Some of the attributes of vision module are determined by the compliant module, wherein requests are written by the compliant module to text files which are read each time that an image is acquired by the imaging device that the vision module is communicating with. These attributes of these requests can be whether video namely a series of still images, is being recorded or not. If the request is made to record, the recording lasts for the duration of the current software application which is indicative of the interactive environment, and operative on the compliant module; whether the current software application operative on the compliant module application is a “polling” or “non-polling” type of application; and the type of software application being operated, for example the game mode of the current software application operative on the compliant module.

The images that are captured in vision module are used to determine the observed motion, for example one or more movement parameters, of the plurality of targets/target identifiers. This evaluation can be performed using an optical flow algorithm, for example based on “Determining Optical Flow” By Berthold K. P. Horn and Brian G. Schunck, published in Artificial Intelligence 17 (1981) 185-203].

The results of this movement assessment can be tuned by setting the number of iterations of the algorithm, the density of the analysis with respect to the resolution of the images and the interaction with the analysis from the previous images. The motion information that is generated is then moulded into 2 distinct forms of motion parameters. The first form is a global motion calculation for predetermined regions of an arena. This configuration of the motion parameter results in a single average measurement of whether a predetermined region moved left, right, up or down. The second form is a percentage calculation that indicates the extent to which a predetermined region moved in a certain direction. With additional normalization of this second form, the percentage of the target motion in the various directions can be calculated. The communication module can use either of these forms by requesting the “non-polling” option, which is associated with form 1 of the movement parameter or the “polling” option which is associated with form 2 of the movement parameter.

The vision module uses the sectioning data that is generated by the sectioning module. In this way, the images, which can be in the form of image matrices that are captured, can be divided into sub-matrices corresponding to the predetermined regions and the motion data or motion parameters that are determined can likewise be ascribed to the appropriate predetermined regions. The motion parameters that are generated in vision module are written to the database such that this database is continuously updated and thus this information can be accessed by all of the vision modules of the object tracking system as well as the communication module.

Furthermore, the vision module includes an optional automatic calibration feature. For example, when the compliant module requests a calibration, it sends signals to the communication module indicating that the crowd is expected, for example if the crowd is instructed, to move in particular directions. These signals are passed from communication module to the various vision modules which can be configured to learn to associate the motion readings with these particular directions. This “learning phase” of the vision module can result in a classifier, for example using Linear Discriminant Analysis, which interprets the motion parameters for the remainder of the duration of the software application operative on the compliant module.

In some embodiments, the vision module is created in the MatLab development environment and is compiled and deployed as an executable application on an appropriate computing device.

### Communication Module 605

The communication module is configured to use the motion information, motion parameters, generated by the vision module and configure them to enable control the software application operative on the compliant module. Information gathered from the database generated by the vision module is modified to fit the requests sent by the compliant module. In some embodiments, the control signals are sent to the compliant module via The “External Interface” class in Flash Action Script 3, however this format of the control signals is dependent on the format of control signals required by the software application operative on the compliant module. The communication module is configured to handle each of these requests from the compliant module and to generate an appropriate response either by sending information back to the compliant module or by modifying/updating a state of operation of the compliant module.

In some embodiments, the communication module is configured to define and communicate to vision module whether the current software application operative on the compliant module uses “polling” or “non-polling” functionality. Additionally, the communication module is configured to identify the operational game mode which is associated with the software application operative on the compliant module. In some embodiments, there can be four possible game modes, which can dictate the motion of the targets. These game modes include: Mode 1—left and right movement only; Mode 2—up and down movement only; Mode 3—left, right and up movement only; and Mode 4—left, right, up and down movement. Depending on the operational game mode, the communication module is configured to sample the movement data in the database in order that the appropriate control signals are provided to the compliant module.

In some embodiments of the invention, the communication module is created in the Microsoft Visual Basic 2008 development environment and is compiled and deployed as an executable application on a suitable computing device. In some embodiments, the communication module includes an embedded ActiveX Flash player which is configured to display the software applications operative on the compliant module.

### Compliant Module 611

The compliant module comprises one or more software applications that are used for the creation of the interactive environment. In some embodiments, the software applications are created in the Adobe Flash CS4 development environment. In some embodiments, these software applications are deployed in the Flash player embedded in the communication module.

In some embodiments of the present invention, a particular compliant module is configured with only one software application, for example a specific game. In some embodiments a plurality of different software applications are operative on a single compliant module.

In some embodiments of the invention, a Flash application is considered to be acceptable for use in the object tracking system according to the present invention if it adheres to the correct communication protocol with communication module. These correct communication protocols include signalling to begin measuring motion, namely enabling activation of the vision module; signalling to end measuring motion and requesting a result; sending information pertinent to modifying motion data, for example one or more movement parameters, thereby enabling the generation of the appropriate control signals for the software application from the motion data; requesting a “leader board” enabling the ranking of predetermined regions, for example top arena sections; sending game reports; signalling to begin/end video capture; signalling to allow the user to select a new software application for operation on the compliant module; and signalling the end of the software application.

### Sectioning Module 609

The section module allows an automatic or manual sectioning of the arena, or other venue for use of the object tracking system of the present invention, based on previously captured images of the field of view of a particular imaging device, wherein this section of the venue is performed prior to the use or operation of the system. The sectioning module enables a user to select a section number and then specify the coordinates of the polygon that defines the perimeter of that section. The saved sectioning coordinates are then automatically retrieved and used by the vision module during evaluation of the movement parameters from the captured images.

In some embodiments, the sectioning module is created in the Microsoft Visual Basic 2008 development environment and can be used either in its compiled version or in the development environment on a computer device during the initial setup of the object tracking system.

### Thresholding Module 617

The thresholding module is used to automatically or manually reduce the noise and adjust the relative motion readings, for example movement parameters, for each predetermined region. The predetermined region coordinates are automatically loaded from the sectioning module and are used to mask the entire image except for the predetermined region of interest. Horizontal and vertical thresholds as well as normalization parameters can be adjusted and saved for each predetermined region, wherein these thresholds can be used during the evaluation of the one or more movement parameters, for example by using an optical flow analysis. The threshold information is automatically loaded into the vision module and is used to apply relative weights to the predetermined region readings, during analysis.

In some embodiments, the thresholding module is created in the MatLab development environment and is compiled and deployed as an executable application on an appropriate computing device. According to embodiments of the present invention, the thresholding module is used solely during setup of the optical tracking system.

### Launch Module 613

According to embodiments, the launch module allows the user to launch any of the available software application operatively associated with the compliant module. Some of the software applications allow the use of video overlays using chroma key/alpha channel and the layouts for the positioning of these components can be also be previewed. The launch module sends these requests made by the user to the communication module which is configured to subsequently launch the appropriate software applications and/or layouts. According to embodiments, a user cannot exit the launch module without a password, thereby providing a level of security for the launching of particular software applications.

According to embodiments of the present invention, the launch module is created in the Microsoft Visual Basic 2008 development environment and is compiled and deployed as an executable application on an appropriate computing device.

### User Interface Module 615

According to embodiments of the invention, the user interface module is a web interface that enables access to the object tracking system. The user interface module can allow the user to preview one or more of the software applications operatively associated with the compliant module. The user interface module can also allow the user to modify one or more of the fields of a software application that require inputs, for example when the software application is related to a polling game with questions and answers. In some embodiments, the user's input regarding software application field modifications can subsequently be added to a database which would subsequently send the updated information to the launch module, for example using an “Adobe AIR” application. In this manner, the user has the ability to access and modify, at least in part, some aspects of the interactive environment.

While above defines a plurality of specific modules operative together in the object tracking system, it would be readily understood by a worker skilled in the art that multiple of the above defined modules can be integrated into a single multi-functional module.

The following provides a hardware setup of the object tracking system in accordance with some embodiments of the present invention. The hardware includes a server, an imaging system and a control station.

### Server

In some embodiments, the server is a rack-mounted machine on which the functional software related to the above defined modules is executed. The serve can be a multi-threaded high-performance computer running the Microsoft Windows XP operating system. The server can comprise 3 Ethernet network interface controllers (NICs) on the system, wherein the first NIC can be a Gigabit adapter and is connected to the imaging system, the second NIC can be connected to an Internet connection to allow remote access to the system and the third NIC can hold the ActiveGigE license.

In some embodiments, the server houses an SD-SDI broadcast-quality video card (with the option to switch to an HD-SDI card). For example, the launch module can be displayed on the “primary” section of a windows extended monitor while the software application operative on the compliant module can be displayed on the “secondary” section of the extended monitor through the SDI. The server can also include a broadcast-quality sound card and also include video and audio outputs that can be integrated with the audio-visual media system of the venue for the presentation of the interactive environment to the targets, namely the people in the venue or arena.

### Imaging System

According to embodiments, the imaging system is the “live” input for the server. The number, orientation and grouping of the one or more imaging devices is dependent on the size and shape of the arena in question. The imaging system comprises Gigabit Ethernet cameras that can be connected directly to a Gigabit Ethernet switch attached to server or can be aggregated to form “imaging device bays” where a collection of imaging device is attached to a switch which is then connected to another switch attached to the server.

In some instances, significant distances are involved, and in said circumstances fiber-optic cable can be used to maintain a desired level of signal integrity. Accordingly, for these instances wherein fiber-optic cable is used, the switches operative with the system must, therefore, be able to accept fiber inputs and outputs.

In some embodiments, the imaging devices are powered by extension cables spanning the arena or they can be powered by “Power over Ethernet” (PoE). In this case, a “PoE-enabled” switch generates signals carrying both Gigabit Ethernet data as well as power. Each of these signals is connected to a splitter (one for each imaging device). The splitter (which is in close proximity to the camera in question) separates the signals and provides two outputs (power and data) to the camera.

### Control Station

According to embodiments, the optical tracking system can be accessed in 2 ways. The first is to attach peripherals, for example a monitor, mouse and keyboard either directly to the Server or through a KVM switch attached to server. The second way is to remotely log in to the “Bomgar Representative Console” using the client login information, which can provide a means for access the launch module. According to embodiments, the user interface module is accessible from any Internet connected computer.

### Interactive Environment

The following describes applications of this technology to the movements of the crowd and sub-segments of that crowd for the purpose of creating interactive entertainment (whether cooperative, competitive or for choice based information generation (polls, quizzes etc)), in particular in the context of large public venues (arenas and stadiums) for entertainment and revenue generation. The system and the techniques described above emphasise the behaviours of individuals of crowds and dynamics of crowd movement.

The present invention may be implemented as mass-participation interactive game applications and entertainment platforms for arenas and stadiums. Implemented live, it would provide an entertainment medium to engage spectators and get them working together or competing against each other. The spectators may be enabled to provide instant feedback, for example, to vote on the next song they want to hear or the highlight videos they want to watch. Exemplary applications such as the ones described below would be useful for filling time-outs and play stoppages with true fan engagement, as well as provided new opportunities for premium sponsored interaction.

The present invention may be implemented as a game system designed specifically to allow fans to play together by moving their arms. The system would be implemented to use the collective movement of a crowd to control video games appearing on a video scoreboard. The movement of fans may be monitored using cameras. For example, a plurality of high-definition cameras situated around the arena may be configured to send images to a server that analyzes the timing, direction and magnitude of the crowd's movement, as a whole or section by section, to generate commands that control a game or answer a poll. The system turns every fan in the arena into a human controller, enabling them to work together or to compete with each other to play a game.

The present invention may be implemented in a polling application that enables fans to “vote” by moving their arms. The system may be configured to calculate the percentages of people waving in a particular direction, and to match that to the fan's choice of videos, favorite music tracks or questions in a mass trivia quiz.

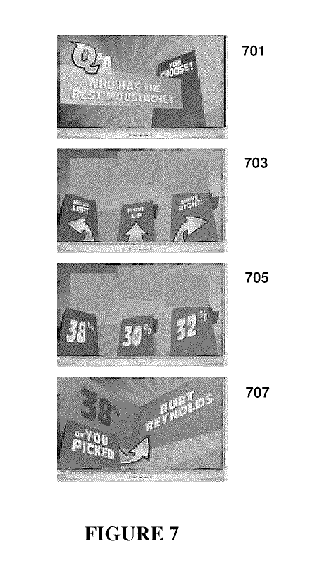

Referring to FIG. 7, an exemplary application that lets fans play a mass trivia quiz is shown. FIG. 7 shows an image of the video scoreboard as the mass trivia quiz is played by the spectators. The fans may be enabled to “vote” on a question, exemplarily shown in 701 as “who has the best moustache” by moving their arms. By a particular movement, for example left, right or up 703 an associated answer can be selected. The system may be configured to calculate the percentages of people waving in a particular direction 705 and to match that to the fan's choice of answers to questions. The system is also configured to provide instant feedback on the fan choice 707.

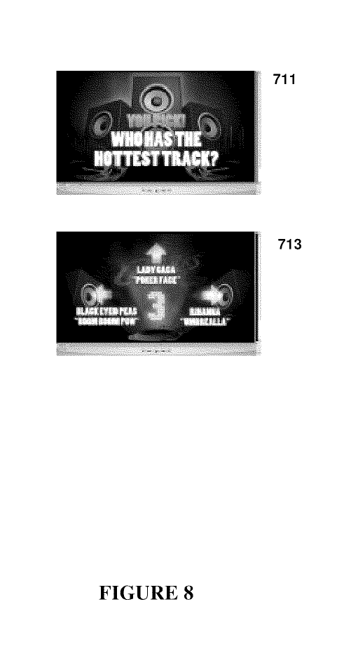

FIG. 8 shows another exemplary application in which fans vote on the “hottest music track”. For example asking the question in 711, and assigning a direction to each of the choices 713. In some embodiments, upon the selection of the “hottest music track” the selected music is played over the music system associated with the venue.

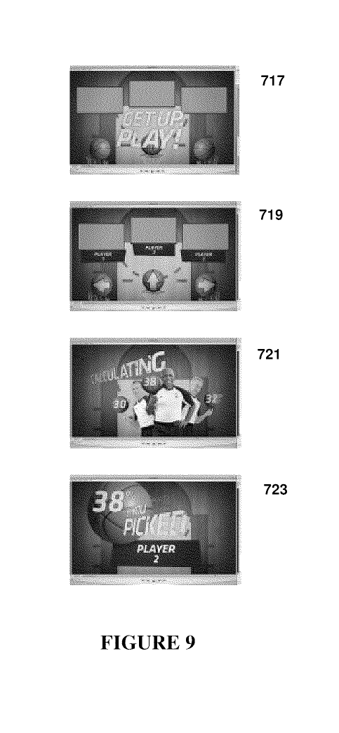

FIG. 9 shows yet another exemplary implementation as a basketball game. In this embodiment, the participants are asked to play 717, select a player 719, and then being provided with the outcome of the selection by the group of participants 721 and 723

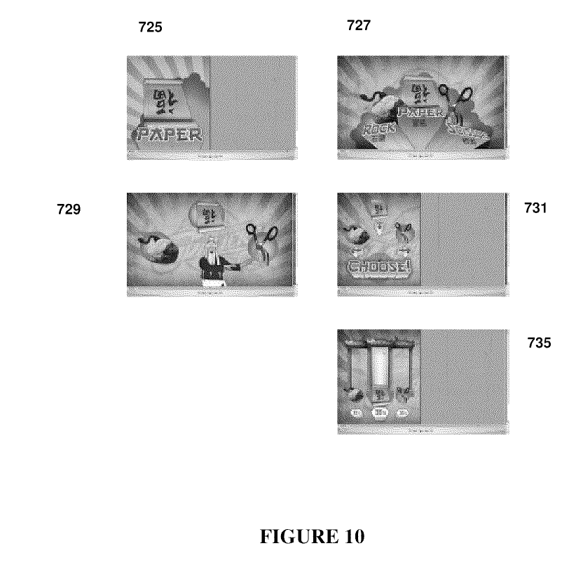

FIG. 10 shows an exemplary application that pits one fan against the entire crowd. The crowd votes for rock, paper or scissors by moving their body in a particular direction as the player reveals his or her choice. The quick nature of this game would allow for a tournament style multiple rounds over the course of the evening. For example, a person secretly selects one of the three choices, the game is introduced to the audience 727, the audience chooses 731, and the selection is made 735, 725, and the winner is presented 729, which in this example was the single contestant as the audience had selected paper.

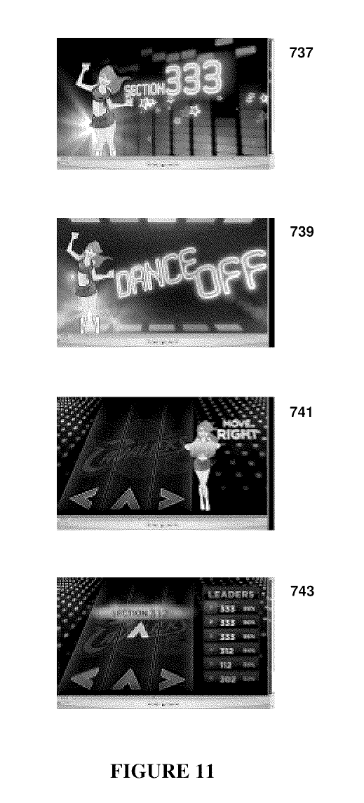

FIG. 11 shows an exemplary “Dance Off” game application in the style of Dance Dance Revolution to get all the spectators dancing to a popular song while corresponding arrows mark the beat on the giant video screens, 737, 739 and 741. Sections may be ranked by the accuracy and timing of their movement with winning sections enjoying the limelight on the big screens 743.

### Example 2

In one embodiment of the present invention, as illustrated in FIG. 2, the described system is provided in an indoor sports arena. The one or more light sources 110 emit an electromagnetic energy 113 in the infrared light spectrum. The one or more light sources 110 are co-located with the one or more cameras 140, which are used as the imaging devices, in order to emit the electromagnetic energy 113 from the light source 110 in the direction of the targets 120. In this specific embodiment, the targets 120 are the participants in the audience, and the target identifiers 130 associated with the targets 120 comprise the retro-reflective material that best reflects the infrared light spectrum. In one embodiment the retro-reflective material that reflects the infrared light spectrum is a silver coloured reflective adhesive tape (sources of such material are, for example, the USA Department of Transportation), the tape can be cut to a 1.5″×3″ rectangular strip and placed on a 4″×6″ flat card stock.

In the present embodiment of the invention, the retro-reflective target identifiers 130 only reflect the infrared light 115 back to the camera 140 since the light source 110 is co-located with the camera 140, allowing the camera 140 to capture the images of the target identifiers 130. In this specific example, where an infrared (IR) light is used, a specialized IR-only filter can be used to further increase the accuracy of detection of the target identifiers captured by the imaging device. The IR-only filter eliminates substantially all of the visible light spectrum, allowing the cameras to see light reflected back in the IR frequency range. The use of the infrared light source which is invisible and harmless to the participants, combined with the retro-reflective material used on or as target identifiers allows the target identifiers to be the brightest objects within the image frame allowing easy detection of the target identifiers. The combination helps to minimize or substantially eliminate the effects of “noise” that may be caused by the imaging of other unwanted objects as target identifiers.

It will be appreciated that, although specific embodiments of the invention have been described herein for purposes of illustration, various modifications may be made without departing from the scope of the invention. In particular, it is within the scope of the invention to provide a computer program product or program element, or a program storage or memory device such as a solid or fluid transmission medium, magnetic or optical wire, tape or disc, or the like, for storing signals readable by a machine, for controlling the operation of a computer and/or firmware according to the method of the invention and/or to structure its components in accordance with the system of the invention.

In addition, while portions of the above discuss the invention as it can be implemented using a generic OS and/or generic hardware, it is within the scope of the present invention that the method, apparatus and computer program product of the invention can equally be implemented to operate using a non-generic OS and/or can use non-generic hardware.

Further, each step of the method may be executed on any general computer, such as a personal computer, server or the like, or system of computers, and pursuant to one or more, or a part of one or more, program elements, modules or objects generated from any programming language, such as C++, C#, Java, PL/1, or the like. In addition, each step, or a file or object or the like implementing each said step, may be executed by special purpose hardware or a circuit module designed for that purpose.

It is obvious that the foregoing embodiments of the invention are examples and can be varied in many ways. Such present or future variations are not to be regarded as a departure from the and scope of the invention, and all such modifications as would be obvious to one skilled in the art are intended to be included within the scope of the following claims.

We claim:

1. An object tracking system configured to track movement of a plurality of targets for modification of an interactive environment, the system comprising:
a) one or more imaging devices, each imaging device configured to capture two or more images of at least some of a plurality of target identifiers, each of the target identifiers associated with one of the plurality of targets and each target identifier responsive to electromagnetic energy; and
b) one or more processing modules operatively coupled to the one or more imaging devices, the one or more processing modules configured to:
i) receive the two or more images;
ii) establish a first location parameter for a predetermined region at least in part based on a first of the two or more images, the predetermined region including one or more of the plurality of target identifiers;
iii) establish a second location parameter for the predetermined region based at least in part on a second of the two or more images;
iv) determine one or more movement parameters based at least in part on the first location parameter and the second location parameter; and
v) modify the interactive environment based at least in part on the one or more movement parameters.

2. The object tracking system according to claim 1, wherein the one or more processing modules are configured to determine the one or more movement parameters using an optical flow technique.

3. The object tracking system according to claim 1, wherein the one or more movement parameters are indicative of movement along one dimension or two dimensions.

4. The object tracking system according to claim 1, further comprising one or more light sources configured to direct the electromagnetic energy towards the plurality of target identifiers.

5. The object tracking system according to claim 1, wherein the plurality of targets and their associate target identifiers are the same.

6. The object tracking system according to claim 1, wherein the plurality of target identifiers are either actively responsive or passively responsive to electromagnetic energy.

7. The object tracking system according to claim 1, wherein the plurality of targets are spectators at a mass spectator event.

8. The object tracking system according to claim 1, wherein the predetermined region is a predefined section of a venue.

9. The object tracking system according to claim 1, wherein the interactive environment is a gaming environment.

10. The object tracking system according to claim 9, wherein the gaming environment is a polling gaming environment.

11. The object tracking system according to claim 1, wherein the one or more target identifiers are representative of one or more brands.

12. The object tracking system according to claim 1, wherein the one or more processing systems are configured to identify one or more target identifiers, wherein the one or more identified targets identifiers are to be tracked.

13. The object tracking system according to claim 1, wherein the one or more processing modules are configured to determine the one or more movement parameters using a thermal imaging technique.

14. The object tracking system according to claim 1, wherein one or more of the target identifiers are responsive to electromagnetic energy of a predetermined wavelength range.

15. A method for tracking movement of a plurality of targets for modification of an interactive environment, the method comprising:
a) capturing two or more images of at least some of a plurality of target identifiers, each of the target identifiers associated with one of the plurality of targets and each target identifier responsive to electromagnetic radiation;
b) establishing a first location parameter for a predetermined region at least in part based on a first of the two or more images, the predetermined region including one or more of the plurality of target identifiers;
c) establishing a second location parameter for the predetermined region based at least in part on a second of the two or more images;
d) determining one or more movement parameters based at least in part on the first location parameter and the second location parameter; and
e) modifying the interactive environment based at least in part on the one or more movement parameters.

16. The method according to claim 15, wherein determining one or more movement parameters is based at least in part on an optical flow evaluation.

17. The method according to claim 15, wherein determining one or more movement parameters is confined to one dimensional movement.

18. The method according to claim 15, wherein determining one or more movement parameters is confined to two dimensional movement.

19. The method according to claim 15, further comprising directing the electromagnetic energy towards the plurality of target identifiers.

20. The method according to claim 15, wherein the interactive environment is a gaming environment.

21. The method according to claim 20, wherein the gaming environment is a polling gaming environment.

22. The method according to claim 15, wherein determining one or more movement parameters is based at least in part on a thermal imaging technique.

23. The method according to claim 15, further comprising identifying one or more target identifiers for tracking movement thereof, prior to establishing the first location parameter.

24. A computer program product for tracking movement of a plurality of targets for modification of an interactive environment, the computer program product comprising code which, when loaded into memory and executed on a processor is adapted to:
a) capture two or more images of at least some of a plurality of target identifiers, each of the target identifiers associated with one of the plurality of targets and each target identifier responsive to electromagnetic radiation;
b) establish a first location parameter for a predetermined region at least in part based on a first of the two or more images, the predetermined region including one or more of the plurality of target identifiers;
c) establish a second location parameter for the predetermined region based at least in part on a second of the two or more images;
d) determine one or more movement parameters based at least in part on the first location parameter and the second location parameter; and
e) modify the interactive environment based at least in part on the one or more movement parameters.

25. The computer program product according to claim 24, wherein the computer program product is adapted to determine one or more movement parameters is based at least in part on an optical flow evaluation.
